(19) United States
(12) Patent Application Publication
(10) Pub. No.: US 2015/0100334 A1
(43) Pub. Date: Apr. 9, 2015

(54) System and Method for Managing Medical Information

(71) Applicants: Chi-Hung Lin, Taichung City (TW); Wei-Lun Tsai, Taichung City (TW); Liang-Yu Lin, Taichung City (TW)

(72) Inventor: Chi-Hung Lin, Taichung City (TW)

(21) Appl. No.: 14/327,725

(22) Filed: Jul. 10, 2014

(30) Foreign Application Priority Data
Oct. 8, 2013 (TW) 102218802

(51) Int. Cl. G06F 19/00; G06F 17/30

(52) U.S. Cl. CPC G06F 19/3456; G06F 17/30; G06F 19/328
USPC 705/2; 235/375

(57) ABSTRACT

A system for managing medical information includes a host device for installation at a first location, an image capturing device, and an end device for installation at a second location. The host device encodes medical information into a barcode, and outputs the barcode to an information carrier. The image capturing device captures an image of the barcode on the information carrier so as to create a barcode image. The end device decodes the barcode image for obtaining the medical information encoded by the host device.

### CROSS-REFERENCE TO RELATED APPLICATION

This application claims priority to Taiwanese Application No. 102218802, filed on Oct. 8, 2013.

### BACKGROUND OF THE INVENTION

1. Field of the Invention

The invention relates to a system and a method for managing medical information.

2. Description of the Related Art

Currently, medical information, such as a prescription, a medical record, medical referral information, and medical care information recorded by a pharmacist for tracking a condition of a chronic patient, is manually transmitted between different medical units, such as hospitals, clinics, pharmacies, etc., by use of written/printed documents.

However, when another pharmacist receives a written/printed prescription, or a doctor receives a medical record, medical referral information, or medical care information recorded using the written document, manual typing (by use of a keyboard, a mouse, etc.) is required for input of the recorded information. Unavoidably, input errors may occur due to carelessness, fatigue, external interference, and so on. In addition, manual typing results in low efficiency.

### SUMMARY OF THE INVENTION

Therefore, an object of the present invention is to provide a medical information management system that may enhance efficiency and precision in transmission of medical information.

According to one aspect of the present invention, a system for managing medical information comprises:

a host device for installation at a first location, the host device including an input module configured for input of medical information, an encoding module configured to encode the medical information into a barcode, and an output module configured to output the barcode to an information carrier;

an image capturing device including a capturing module configured to capture an image of the barcode on the information carrier, an image processing module configured to create a barcode image according to the image of the barcode captured by the capturing module, and a first communication module configured to transmit the barcode image; and

an end device for installation at a second location, the end device including a second communication module configured to receive the barcode image transmitted by the first communication module, and a decoding module configured to decode the barcode image received by the second communication module for obtaining the medical information encoded by the host device.

Another object of the present invention is to provide a medical information management method that may enhance efficiency and precision in transmission of medical information.

According to another aspect of the present invention, a method for managing medical information comprises the steps of:

receiving, by a host device installed at a first location, the medical information;

encoding, by the host device, the medical information into a barcode;

outputting, by the host device, the barcode to an information carrier;

capturing, by an image capturing device, an image of the barcode on the information carrier;

creating, by the image capturing device, a barcode image according to the image of the barcode thus captured;

transmitting, by the image capturing device, the barcode image;

receiving, by an end device installed at a second location, the barcode image transmitted by the image capturing device; and

decoding, by the end device, the barcode image to obtain the medical information encoded by the host device.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram showing a preferred embodiment of the system for managing medical information according to the present invention;

FIG. 2 is a block diagram of the preferred embodiment;

FIG. 3 is a schematic diagram showing a first exemplary application of the preferred embodiment in which the medical information includes a medical record and medical referral information;

FIG. 4 is a schematic diagram showing a second exemplary application of the preferred embodiment in which the medical information is a prescription;

FIG. 5 is a schematic diagram showing a third exemplary application of the preferred embodiment in which the medical information is medical care information;

FIG. 6 is a schematic diagram showing that an information carrier of the preferred embodiment is an electronic device; and

FIG. 7 is a flow diagram illustrating steps of a method for managing the medical information according to the present invention.

### DETAILED DESCRIPTION OF THE PREFERRED EMBODIMENT

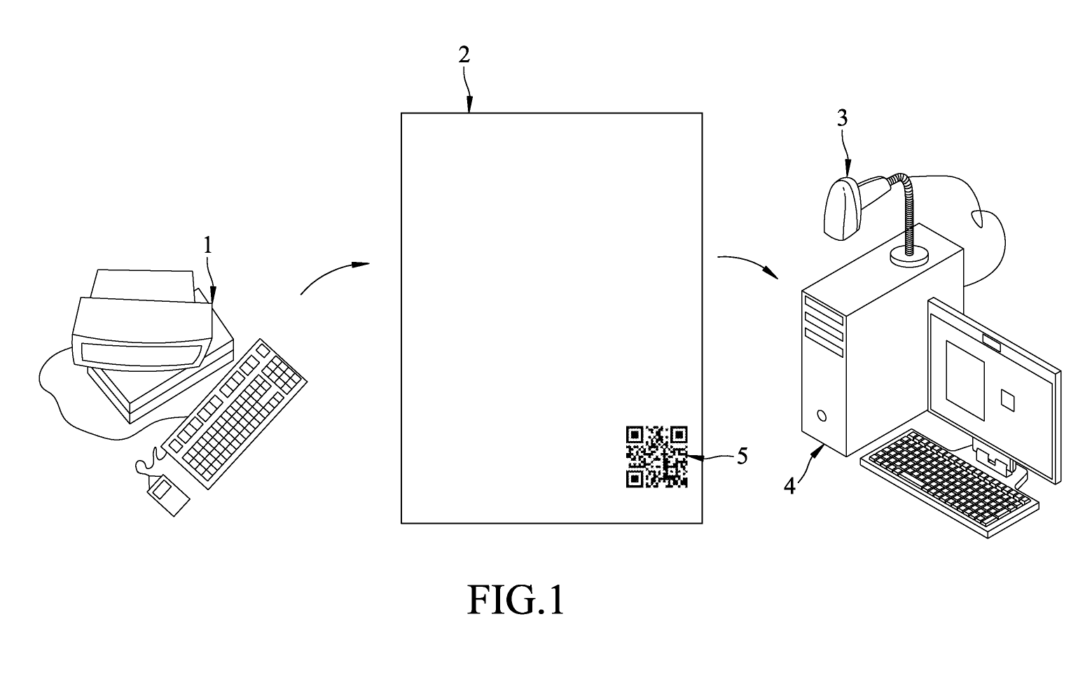

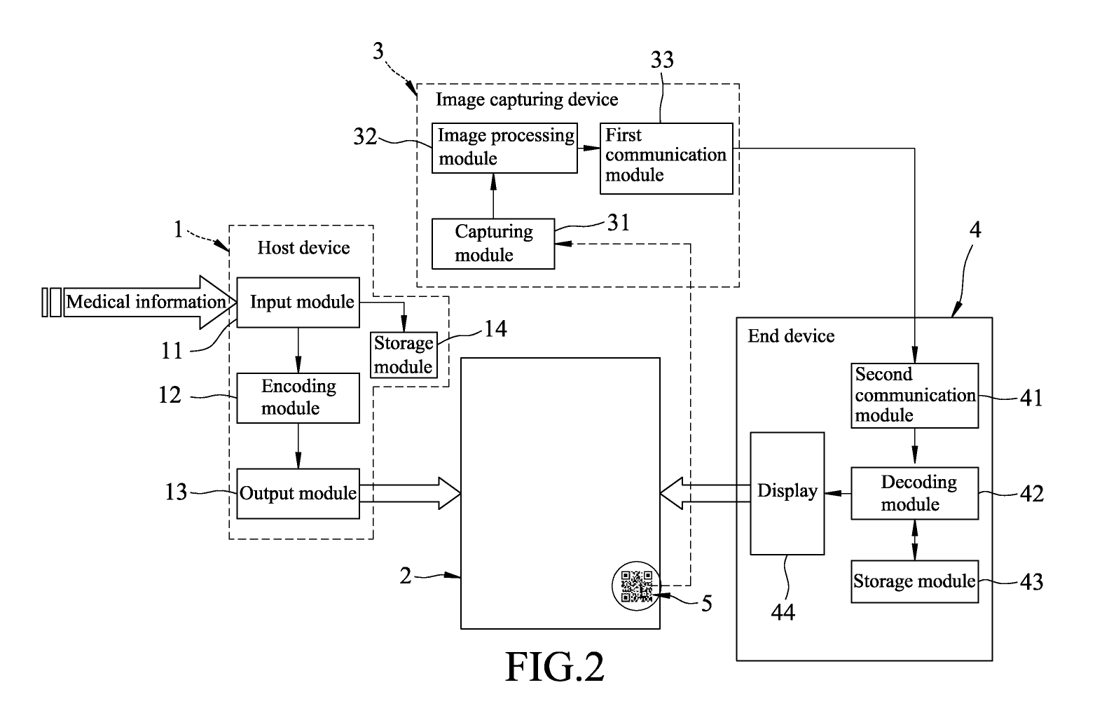

Referring to FIGS. 1 and 2, the preferred embodiment of the system for managing medical information according to this invention is adapted for transmission of the medical information, and includes a host device 1, an information carrier 2, an image capturing device 3 and an end device 4.

The host device 1 is installed at a first location, and includes an input module 11 configured for input of the medical information, an encoding module 12 configured to encode the medical information into a barcode 5, an output module 13 configured to output the barcode 5 to the information carrier 2, and a storage module 14 for storing the medical information inputted using the input module 11. The barcode 5 may be a one-dimensional barcode or a two-dimensional barcode. In this embodiment, the barcode 5 is a quick response code (QR code), but is not limited thereto. Note that the input module 11 may be a keyboard, a mouse, a touch screen, or a transmission interface that inputs the medical information via the Internet or a storage medium.

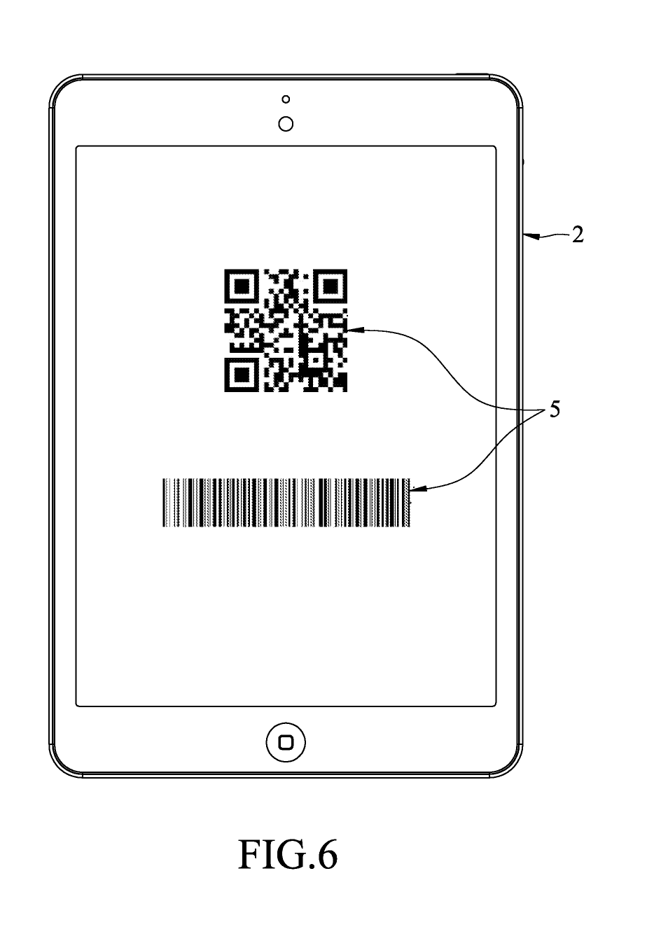

In this embodiment, the information carrier 2 is a piece of paper, and may be, but is not limited to, an electronic device having a display function (see FIG. 6), or an electronic paper display in other embodiments.

In this embodiment, the image capturing device 3 is a scanner capable of image capturing, and includes a capturing module 31 configured to capture an image of the barcode 5 on the information carrier 2, an image processing module 32 configured to create a barcode image according to the image of the barcode 5 captured by the capturing module 31, and a first communication module 33 configured to transmit the barcode image. Note that the image capturing device 3 may be a camera, a video camera, or a smartphone, but is not limited thereto.

The end device 4 is installed at a second location, and includes a second communication module 41 configured to communicate with the first communication module 33 for receiving the barcode image therefrom, a decoding module 42 configured to decode the barcode image received by the second communication module 41 for obtaining the medical information encoded by the host device 1, a storage module 43 for storing the medical information decoded by the decoding module 42, and a display 44 for displaying the medical information.

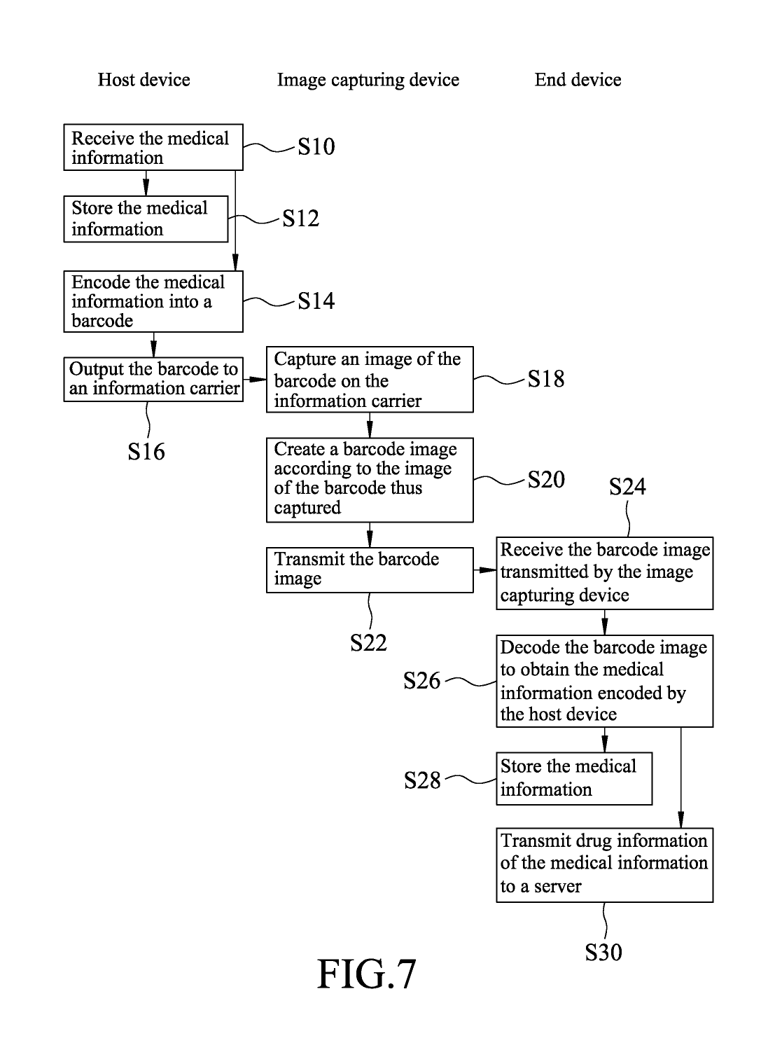

Referring to FIG. 7, the system of the preferred embodiment manages the medical information by implementing a method that includes the following steps:

Step S10: The input module 11 of the host device 1 receives the medical information.

Step S12: The storage module 14 of the host device 1 stores the medical information therein.

Step S14: The encoding module 12 of the host device 1 encodes the medical information into a barcode 5.

Step S16: The output module 13 of the host device 1 outputs the barcode 5 to an information carrier 2.

Step S18: The capturing module 31 of the image capturing device 3 captures an image of the barcode 5 on the information carrier 2.

Step S20: The image processing module 32 of the image capturing device 3 creates a barcode image according to the image of the barcode 5 thus captured.

Step S22: The first communication module 33 of the image capturing device 3 transmits the barcode image.

Step S24: The second communication module 41 of the end device 4 receives the barcode image transmitted by the image capturing device 3.

Step S26: The decoding module 42 of the end device 4 decodes the barcode image to obtain the medical information encoded by the host device 1.

Step S28: The storage module 43 of the end device 4 stores the medical information therein.

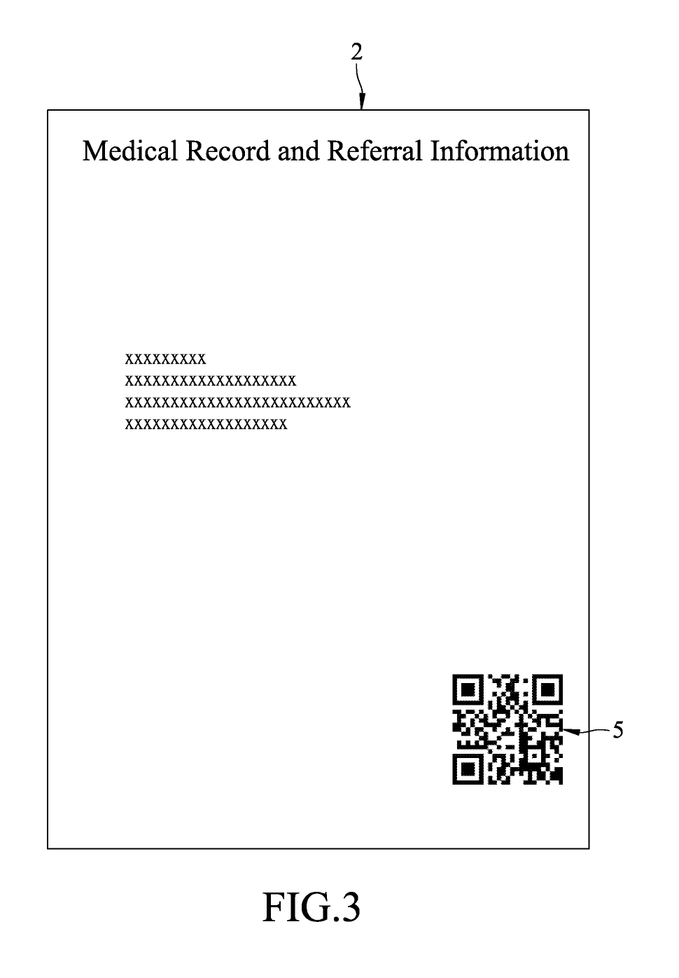

Further referring to FIG. 3 for a first exemplary application of the preferred embodiment, the medical information includes a medical record and medical referral information, the host device 1 belongs to a first medical unit at the first location, and the end device belongs to a second medical unit at the second location. When a patient is transferred from the first medical unit to the second medical unit due to equipment problems or patient's requirements, medical personnel of the first medical unit may only need to input or load the medical record and the medical referral information using the input module 11 of the host device 1, the encoding module 12 encodes the medical record and the medical referral information into the barcode 5, and the output module 13 outputs the barcode 5 to the information carrier 2. In this embodiment, the medical information and the barcode 5 are outputted to the information carrier 2 which is a piece of paper by printing, so as to create a medical referral letter.

When the patient, patient's relatives, or medical personnel takes the information carrier 2 to the second medical unit, the medical personnel of the second medical unit may only need to scan the barcode 5 using the image capturing device 3, so that the capturing module 31 reads the barcode 5, the image processing module 32 creates the barcode image, and the barcode image is transmitted to the end device 4 via the first and second communication modules 33, 41. Then, the decoding module 42 of the end device 4 of the second medical unit decodes the barcode image for obtaining and storing the medical record and the medical referral information contained in the information carrier 2 (i.e., the medical referral letter) in the storage module 43. The medical personnel may acquire the patient's condition via the display 44, other electronic devices (not shown) connected to the end device 4 or a printed document, to proceed with corresponding examination.

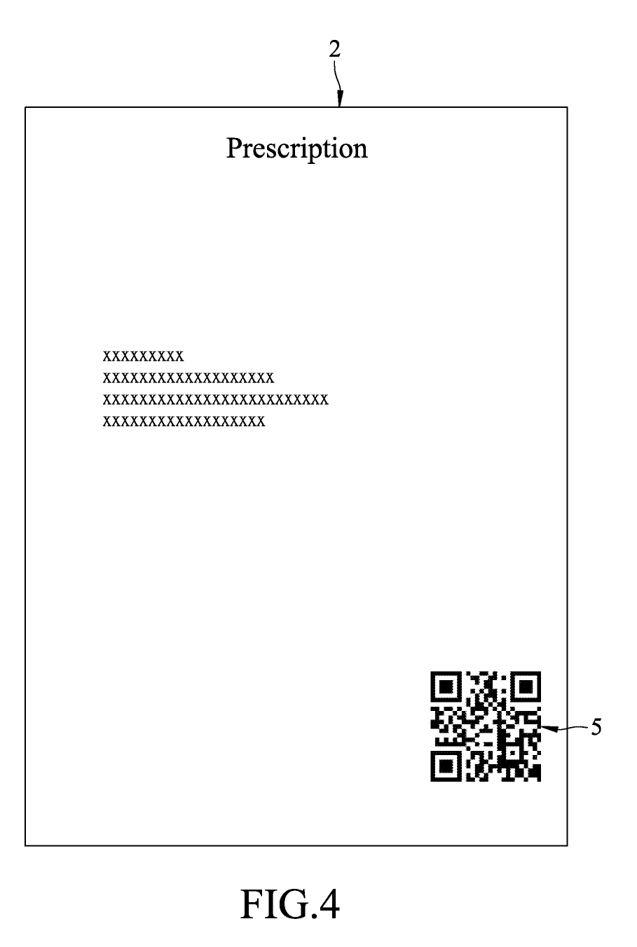

Referring to FIGS. 1, 2 and 4 for a second exemplary application of the preferred embodiment, the medical information is a prescription including drug information, the host device 1 belongs to a medical unit at the first location, and the end device 4 belongs to a pharmacy at the second location. After examination by a doctor of the medical unit, the doctor may input the prescription through the input module 11 of the host device 1, the encoding module 12 encodes the prescription into the barcode 5, and the output module 13 outputs the barcode 5 to the information carrier 2. In this embodiment, the barcode 5 is outputted to the information carrier 2 which is a piece of paper by printing, so as to create a prescription letter.

When the patient, patient's relatives, or medical personnel takes the information carrier 2 to the pharmacy for getting drugs, a pharmacist of the pharmacy may only need to scan the barcode 5 using the image capturing device 3, so that the capturing module 31 reads the barcode 5, the image processing module 32 creates the barcode image, and the barcode image is transmitted to the end device 4 via the first and second communication modules 33, 41. Then, the decoding module 42 of the end device 4 of the second medical unit decodes the barcode image for obtaining and storing the prescription contained in the information carrier 2 (i.e., the prescription letter) in the storage module 43. The pharmacist may check accuracy of the prescription via the display 44, and dispense the prescription accordingly.

In this application, after the end device 4 obtains the drug information by decoding the barcode image, the end device 4 may transmit via the second communication module 41 the drug information to a server managed by a government agency responsible for health insurance benefits, as shown in step S30 in FIG. 7. If the drug information contains information of restricted drugs, other pharmacies may obtain the same information by connection to the server, so as to prevent the same patient from illegally obtaining an unnecessary amount of restricted drugs using the same prescription.

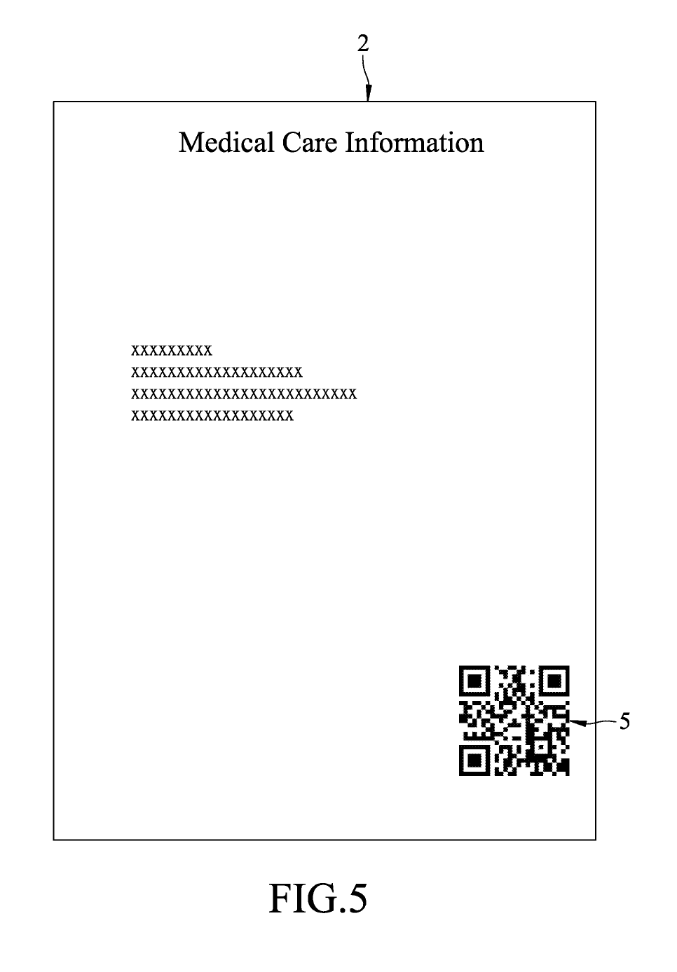

Referring to FIGS. 1, 2 and 5 for a third exemplary application of the preferred embodiment, the medical information is medical care information, the host device 1 belongs to a pharmacist at the first location, and the end device 4 belongs to a medical unit at the second location. When a chronic patient provides the pharmacist with feedback on medication problems, abnormal drug reaction, or changes in illness condition, the pharmacist may input the medical care information through the input module 11 of the host device 1, the encoding module 12 encodes the medical care information into the barcode 5, and the output module 13 outputs the barcode 5 to the information carrier 2. In this embodiment, the barcode 5 is outputted to the information carrier 2 which is a piece of paper by printing, so as to create a suggestion letter.

When the patient takes the information carrier 2 to the medical unit at the second location, medical personnel may only need to scan the barcode 5 using the image capturing device 3, so that the capturing module 31 reads the barcode 5, the image processing module 32 creates the barcode image, and the barcode image is transmitted to the end device 4 via the first and second communication modules 33, 41. Then, the decoding module 42 of the end device 4 of the second medical unit decodes the barcode image for obtaining and storing the medical care information contained in the information carrier 2 (i.e., the suggestion letter) in the storage module 43. The medical personnel may check the medical care information via the display 44, other electronic devices (not shown) connected to the end device 4, or printed documents, so as to be quickly aware of the medication problems, the abnormal drug reaction, or the changes in illness condition of the chronic patient, and to proceed with corresponding examination.

To sum up, the present invention enables quick obtaining of medical information by reading the barcode 5, to thereby reduce manual typing or repeated typing in transmission of the medical information, to enhance time efficiency and precision in transmission of the medical information, and to prevent restricted drugs from being repeatedly obtained using the same prescription. Efficiency of medical personnel in collecting and processing medical information may thus be greatly promoted.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A system for managing medical information, comprising:
a host device for installation at a first location, said host device including an input module configured for input of medical information, an encoding module configured to encode the medical information into a barcode, and an output module configured to output the barcode to an information carrier;
an image capturing device including a capturing module configured to capture an image of the barcode on the information carrier, an image processing module configured to create a barcode image according to the image of the barcode captured by said capturing module, and a first communication module configured to transmit the barcode image; and
an end device for installation at a second location, said end device including a second communication module configured to receive the barcode image transmitted by said first communication module, and a decoding module configured to decode the barcode image received by said second communication module for obtaining the medical information encoded by said host device.

2. The system as claimed in claim 1, wherein the medical information is a prescription including drug information, and said end device further includes a processing module configured to transmit via said second communication module the drug information to a server managed by an agency responsible for insurance benefits.

3. The system as claimed in claim 1, wherein said encoding module of said host device is configured to encode the medical information into one of a one-dimensional barcode and a two-dimensional barcode.

4. The system as claimed in claim 1, wherein the information carrier is one of an electronic device having a display function, a piece of paper, and an electronic paper display.

5. The system as claimed in claim 1, wherein at least one of said host device and said end device further includes a storage module configured to store the medical information.

6. The system as claimed in claim 1, wherein the first location is associated with a first medical unit, and the second location is associated with a second medical unit that is different from the first medical unit.

7. The method as claimed in claim 1, wherein the first location is associated with a pharmacy, and the second location is associated with a medical unit.

8. The system as claimed in claim 1, wherein the medical information includes at least one type of information selected from a prescription, a medical record, medical referral information, and medical care information.

9. A method for managing medical information, comprising the steps of:
receiving, by a host device installed at a first location, the medical information;
encoding, by the host device, the medical information into a barcode;
outputting, by the host device, the barcode to an information carrier;
capturing, by an image capturing device, an image of the barcode on the information carrier;
creating, by the image capturing device, a barcode image according to the image of the barcode thus captured;
transmitting, by the image capturing device, the barcode image;
receiving, by an end device installed at a second location, the barcode image transmitted by the image capturing device; and
decoding, by the end device, the barcode image to obtain the medical information encoded by the host device.

10. The method as claimed in claim 9, wherein the medical information is a prescription including drug information, said method further comprising:
transmitting, by the end device, the drug information to a server managed by an agency responsible for insurance benefits after the decoding step.

11. The method as claimed in claim 9, wherein the barcode is one of a one-dimensional barcode and a two-dimensional barcode.

12. The method as claimed in claim 9, wherein the information carrier is one of an electronic device having a display function, a piece of paper, and an electronic paper display.

13. The method as claimed in claim 9, further comprising storing, by the host device, the medical information therein.

14. The method as claimed in claim 13, further comprising storing, by the end device, the medical information therein after the decoding step.

15. The method as claimed in claim 9, further comprising storing, by the end device, the medical information therein after the decoding step.

16. The method as claimed in claim 9, wherein the first location is associated with a first medical unit, and the second location is associated with a second medical unit that is different from the first medical unit.

17. The method as claimed in claim 9, wherein the first location is associated with a pharmacy, and the second location is associated with a medical unit.

18. The method as claimed in claim 9, wherein the medical information includes at least one type of information selected from a prescription, a medical record, medical referral information, and medical care information.
